(19) United States
(12) Patent Application Publication
(10) Pub. No.: US 2015/0210817 A1
(43) Pub. Date: Jul. 30, 2015

(54) MELAMINE RESIN FOAM MATERIAL COMPRISING AN ANORGANIC FILLER MATERIAL HAVING A HIGH DENSITY

(71) Applicant: BASF SE, Ludwigshafen (DE)

(72) Inventors: Tobias Heinz Steinke, Speyer (DE); Günter Fink, Maxdorf (DE)

(73) Assignee: BASF SE, Ludwigshafen (DE)

(21) Appl. No.: 14/427,424

(22) PCT Filed: Sep. 10, 2013
(86) PCT No.: PCT/EP2013/068667

§ 371 Date: Mar. 11, 2015

(30) Foreign Application Priority Data
Sep. 12, 2012 (EP) 12184087.0

(51) Int. Cl. C08J 9/00

(52) U.S. Cl. CPC C08J 9/0066; C08J 2361/28

(57) ABSTRACT

A melamine-formaldehyde foam comprises from 80% to 98% by weight of at least one inorganic filling material, based on the total weight of the at least one inorganic filling material plus melmine-formaldehyde precondensate used for foam production, wherein the at least one inoganic filling material has a density of at least 3 g/cm³.

The present invention relates to melamine resin films, processes for production thereof and the use thereof.

WO 2012/059493 discloses foaming up melamine resins with inorganic filling materials. The foamed melamine-formaldehyde materials comprise from 80% to 98% by weight of an inorganic filling material, wherein the % by weight based on the total weight of inorganic filling material plus melamine-formaldehyde precondensate used for foam production. Inorganic materials described comprise quartz, olivine, basalt, glass spheres, glass fibers, ceramic spheres, clay minerals, sulfates, carbonates, kieselguhr, silicates, colloidal silica and mixtures thereof. These inorganic filling materials are typically finely divided, i.e., they have a particle size <50 μm. They further generally have an irregular shape and surface morphology.

EP-A-1 146 070 and WO-A-2007/23118 disclose impregnating melamine-formaldehyde foams with an ammonium salt and with sodium silicate, respectively, to improve the fire characteristics of these foams. However, the foams obtained leave something to be desired as far as their mechanical properties are concerned.

DE-A-10 2007 009127 discloses fiber-reinforced foams based on melamine-formaldehyde resins having a fiber content of 0.5% to 50% by weight. The fibrous filler used comprises short or long fibers of glass, carbon or melamine resin.

WO-A-2009/021963 discloses a process for producing an abrasive foam on the basis of a melamine-formaldehyde condensation product comprising 0.01% to 50% by weight of inorganic nanoparticles based on the weight of the precondensate.

It is an object of the present invention to remedy the aforementioned disadvantages and, more particularly, to provide formaldehyde-melamine resin foams having improved mechanical properties, especially with regard to elasticity and compressive strength, coupled with good fire properties.

We have found that this object is achieved by a melamine-formaldehyde foam comprising from 80% to 98% by weight of at least one inorganic filling material, based on the total weight of the at least one inorganic filling material plus melamine-formaldehyde precondensate used for foam production, wherein the at least one inorganic filling material has a density of at least 3 g/cm³.

The present invention further provides a process for producing the melamine-formaldehyde foam of the present invention which process comprises at least one melamine-formaldehyde precondensate, optionally at least one solvent, optionally at least one acid, optionally at least one dispersant, at least one blowing agent and at least one inorganic filling material having a density of at least 3 g/cm³ being mixed and foaming this mixture at a temperature above the boiling temperature of the at least one blowing agent, and also for the use of the melamine-formaldehyde foam of the present invention in building construction, automobile, ship and track vehicle construction, the construction of spacecraft or in the upholstery industry.

The melamine-formaldehyde foam of the present invention comprises by definition from 80% to 98% by weight, preferably from 80% to 95% by weight and more preferably from 80% to 90% by weight of at least one, for example 1 to 10, preferably 1 to 5, more preferably 1 to 3, even more preferably 1 or 2 and most preferably one inorganic filling material having a density of at least 3 g/cm³, all based on the total weight of the at least one inorganic filling material plus melamine-formaldehyde precondensate used for foam production.

The at least one inorganic filling material which is present according to the invention has a density of at least 3 g/cm³, preferably at least 3.5 g/cm³ and more preferably at least 4.0 g/cm³. In a preferred embodiment, the density of the inorganic filling material used according to the present invention as at most 7 g/cm³.

The at least one inorganic filling material having a density of at least 3 g/cm³ is preferably selected from the group consisting of sands, for example based on oxides, e.g., oxides of aluminum, magnesium, zirconium and titanium, mixed oxides e.g. barium-aluminum titanate, silicates, e.g., zircon silicate, olivine, silimanite, andalusite, mullite, mixed silicates, e.g., ceramics, glass-ceramics, sulfates, for example barium sulfate, carbonates, for example barium carbonate, or mixtures of two or more of the materials mentioned.

It is preferable for the purposes of the present invention for the at least one inorganic filling material having a density of at least 3 g/cm³ to be selected from the group consisting of oxides, silicates, mixed silicates, sulfates, carbonates and mixtures thereof.

In a preferred embodiment, the at least one inorganic filling material having a density of at least 3 g/cm³ has an average particle diameter (Z-average via light scattering, Malvern, Fraunhofer diffraction) of 0.05 mm to 2 mm, more preferably 0.1 to 1 mm, even more preferably 0.1 to 0.5 mm and most preferably 0.2 to 0.4 mm.

The at least one inorganic filling material used according to the present invention has a density of at least 3 g/cm³. This density, stipulated by the present invention, is preferably acquired by the at least one inorganic filling material in the present invention because said at least one inorganic filling material is present in particles having the recited preferred sizes and comprises at least one binder.

The at least one inorganic filler material used according to the present invention may generally have any desired shape or form. A particularly preferred inorganic filling material, preferably having the abovementioned average particle diameter is in the form of particles where the ratio of the longest spatial axis to the shortest spatial axis of the particles is more preferably in the range from 2:1 to 1:1. Particular preference for the purposes of the present invention is given to at least partly spherical inorganic filling materials.

The present invention therefore relates with preference to the melamine-formaldehyde foam of the present invention wherein the at least one inorganic filling material having a density of at least 3 g/cm³ is at least partly present as spherical particles.

In a particularly preferred embodiment of the present invention, the at least one inorganic filling material having a density of at least 3 g/cm³ comprises at least one binder. The binder, the presence of which is preferred, may be a polymeric binder or an inorganic binder for example. The binder of the present invention may form an essentially homogeneous mixture with the at least one inorganic filling material. In a further embodiment, the binder may also be present in a layer on the inorganic filling material. It is also possible for the binder of the present invention to form an essentially homogeneous mixture with the at least one inorganic filling material at the same time also be present in a layer on the inorganic filling material.

In a preferred embodiment of the melamine-formaldehyde foam according to the present invention, the at least one binder is selected from the group consisting of thermosets, thermoplastics, inorganic binders and mixtures thereof.

The present invention accordingly relates with preference to the melamine-formaldehyde foam of the present invention wherein the at least one binder is selected from the group consisting of thermosets, thermoplastics, inorganic binders and mixtures thereof.

A preferably present organic binder is generally present in an amount of 80% to 99% by weight, preferably 85% to 99% by weight and more preferably 90% to 99% by weight, all based on the total weight of polymeric binder and at least one inorganic filling material.

A preferably present inorganic binder is generally present in an amount of 30% to 99% by weight, preferably 50% to 95% by weight, more preferably 60% to 95% by weight and even more preferably 70% to 90% by weight, all based on the total weight of inorganic binder and at least one inorganic filling material.

Any polymeric material capable of binding the at least one inorganic filling material present according to the present invention can generally be used in the present invention as polymeric binder.

Useful polymeric binders include more particularly thermoset entities, preferably selected from the group consisting of melamine-formaldehyde resins, polyurethane resins, polyester resins or epoxy resins and mixtures thereof. These are known to a person skilled in the art. Such resins may be found for example in Encyclopedia of Polymer Science and Technology (Wiley) under the following chapter headings: a) Polyesters, unsaturated: Edition 3, Vol. 11, 2004, pp. 41-64; b) Polyurethanes: Edition 3, Vol. 4. 2003, pp. 26-72 and c) Epoxy resins: Edition 3, Vol. 9, 2004, pp. 678-804. Furthermore, Ullmann's Encyclopedia of Industrial Chemistry (Wiley) contains the following chapters: a) Polyester resins, unsaturated: Edition 6, Vol. 28, 2003, pp. 65-74; b) Polyurethanes: Edition 6, Vol. 28, 2003, pp. 667-722 and c) Epoxy resins: Edition 6, Vol. 12, 2003, pp. 285-303. Furthermore, amino- or hydroxy-functionalized polymers, more particularly a polyvinylamine or polyvinyl alcohol can be used.

The present invention accordingly relates with preference to the melamine-formaldehyde foam of the present invention wherein the at least one binder is a thermoset selected from the group consisting of melamine-formaldehyde resins, polyurethane resins, polyester resins, epoxy resins and mixtures thereof.

It is further possible to use thermoplastic entities. Useful thermoplastic materials of construction include for example polyethylene, polypropylene, polyester, polycarbonate and polyamide, preferably thermoplastic materials of construction which have poor fire behavior, for example polytetrafluoroethylene (PTFE), polysulfones (PESU), polyetherimide (PEI) and polyethylene sulfide (PPS). Ullmann's Encyclopedia of Industrial Chemistry (Wiley) contains the following chapters regarding the thermoplastic materials mentioned: a) polyethylene, edition 6, Vol. 28, 2003, pp. 393-427; b) polypropylene, edition 6, Vol. 28, 2003, pp. 428-461; c) Polyesters, Edition 6, Vol. 28, 2003, pp. 75-102; d) Polycarbonates. Edition 6, Vol. 28, 2003, pp. 55-63; e) Polyamides. Edition 6, Vol. 28, 2003, pp. 25-54, f) Polymers, High-Temperature Edition 6, Vol. 28, 2003, pp. 351-376.

The present invention accordingly relates with preference to the melamine-formaldehyde foam of the present invention wherein the at least one binder is a thermoplastic selected from the group consisting of polyethylene, polypropylene, polyesters, polycarbonates, polyamides and mixtures thereof.

It is similarly possible to use inorganic binders selected from the group consisting of phosphate, silicate, borates and mixtures thereof, for example waterglass (Woelliner GmbH) or amorphous silica dispersions (Levasil, H. C. Stark) or combinations thereof.

The present invention accordingly relates with preference to the melamine-formaldehyde foam of the present invention wherein the at least one inorganic binder is selected from the group consisting of phosphates, silicates, borates and mixtures thereof.

The at least one inorganic filling material may also display chemical functionalizations at its surface to improve attachment to the foam structure. The chemical functionalization of the surfaces of the at least one inorganic filling material is known in principle to a person skilled in the art and is described in WO2005/103107 for example. Inorganic filling materials having a density of at least 3 g/cm³, which are in accordance with the present invention, may be for example coated by methods known to a person skilled in the art. This can be effected for example via a spraying device in a mixing device, for example in an intensive mixer, for example from Eirich. This ensures homogeneous wetting of filling materials. In a special embodiment, the coating material is not allowed to fully cure before being introduced into the melamine-formaldehyde precondensate in order that the attachment in the foam may be enhanced.

The at least one inorganic filling material having a density of at least 3 g/cm³, which is used according to the present invention, can be formed in various ways known to a person skilled in the art.

Typical processes for forming inorganic filling materials preferred according to the present invention, especially as dust-free, free-flowing pellets from pulverulent materials, are known to a person skilled in the art, see for example a) Heinze, G., Handbuch der Agglomerationstechnik, Weinheim 2000; b) Pietsch, W. B., Agglomeration Processes: Phenomena, Technologies, Equipment, Weinheim 2002, c) Serno, P., Kleinebudde, P., Knop, K., Granulieren: Grundlagen, Verfahren, Formulierungen, Aulendorf 2006, d) Ullmann's Encyclopedia of Industrial Chemistry (Wiley), Fertilizers, 4. Granulation, Edition 5, Vol. A10, 1987, pp. 374-388.

In principle, pelletization can be subdivided into two processes: a) dry pelletization and b) moist pelletization.

In the dry process, pulverulent solids are processed into pellet material under pressure and/or heat. This may be done batchwise, for example in the form of direct tableting. Still further auxiliary materials are required depending on the substance properties. Size enlargement of finely divided bulk material using roll compactors (counterrotating rolls) is an example of a continuous process. The densifying operation produces a flat, plate-shaped agglomerate. In the compacting-type pelletization process, compacting is followed by comminution.

In addition, inorganic filling materials suitable for the purposes of the present invention can be produced by moist pelletization. In moist pelletization, liquid binders are sprayed onto the finely pulverulent solids. Pelletization can be effected using for example roller, mixed fluidized-bed processes.

The principle of the fluidized bed is based on a gas being passed through a pulverulent accumulation of solids until the gravity of the individual particles is overcome to form an agitated bed that is like a fluid. The fluidized particles are wetted with a binder, preferably with one of the abovementioned binders, more preferably with a thermoset and/or inorganic binder, via spray nozzles. After being sprayed with the binder liquid, the particles adhere together to form the desired size of agglomerate. The materials applied via spray nozzles are liquids, melts or suspensions, see inter alia H. Uhlemann, L. Mörl, Wirbelschicht-Sprühgranulation, Berlin 2000, p. 69 to 125.

Inorganic filling materials suitable for the purposes of the present invention are further also obtainable by extrusion of polymer melts, preferably of the abovementioned polymer binders, more preferably thermoplastic binders, with the corresponding inorganic materials and subsequent pelletization, especially underwater pelletization. Underwater pelletization is accomplished for example using rotated bladed heads running on hard-metal disks. The disks preferably have holes, which determine the basic size. Shape, weight and further parameters can be finely controlled from the outside in the system via rotary speed, material throughput and temperatures, see also Ullmann's Encyclopedia of Industrial Chemistry (Wiley) Plastics Processing, 1. Processing of Thermoplastics Edition 6, Vol. 27, pages 450 to 486.

The present invention accordingly relates with preference to the melamine-formaldehyde foam of the present invention wherein the at least one inorganic filling material is obtained via pelletization processes, for example dry or moist pelletization, and/or extrusion processes.

The melamine-formaldehyde foam of the present invention is generally an open-cell scaffolding of foamed material, the scaffolding comprising a multiplicity of interconnected, three-dimensionally branched struts, and in each of which the at least one inorganic filling material having a density of at least 3 g/cm³ is preferably at least partly embedded into the pore structure. The particle size of the at least one inorganic filling material preferably corresponds for the purposes of the present invention to the average pore diameter of the foam structure (d₅₀ value, number-averaged, determined via optical or electronic microscopy combined with image analysis). In the context of the present invention, “at least partly” is to be understood as meaning at least 60%, preferably at least 70%, more preferably at least 80% and most preferably at least 90%.

The present invention accordingly relates with preference to the melamine-formaldehyde foam of the present invention wherein the at least one inorganic filling material having a density of at least 3 g/cm³ is at least partly embedded into the pore structure.

The at least one inorganic filling material in this preferred embodiment can thus be ideally bound into the pore structure of the open-cell foam and immobilized from all sides of the pore scaffolding. A structure of this type, which is in accordance with the present invention, cannot be produced by subsequently impregnating the foam with inorganic filling materials in accordance with the prior art, since for this the particle size of the inorganic fillers always has to be chosen such that the particle size is smaller than the pore size of the foam in order that distribution in the entire foam may be ensured.

The melamine-formaldehyde precondensate used for producing the melamine-formaldehyde foam of the present invention generally has a molar ratio of formaldehyde to melamine in the range from 5:1 to 1.3:1 and preferably in the range from 3.5:1 to 1.5:1.

The melamine-formaldehyde condensation product, in addition to melamine, may also comprise from 0% to 50% by weight, preferably from 0% to 40% by weight, more preferably from 0% to 30% by weight and especially from 0% to 20% by weight, all based on the sum total of melamine and any further thermoset-formers, of other thermoset-formers. Additionally present thermoset-formers are selected for example from the group consisting of alkyl- and aryl-substituted melamine, urea, urethanes, carboxamides, dicyandiamides, guanidine, sulfurylamides, sulfonamides, aliphatic amines, glycols, phenols, derivatives and mixtures thereof.

The melamine-formaldehyde condensation product, in addition to formaldehyde, may further also comprise from 0% to 50% by weight, preferably from 0% to 40% by weight, more preferably from 0% to 30% by weight and especially from 0% to 20% by weight, all based on the sum total of formaldehyde and any further aldehydes, of other aldehydes in cocondensed form. Additionally present aldehydes are selected for example from the group consisting of acetaldehyde, trimethylolacetaldehyde, acrolein, benzaldehyde, furfural, glyoxal, glutaraldehyde, phthalaldehyde, terephthalaldehyde and their mixtures. Further details concerning melamine-formaldehyde condensation products are found in Houben-Weyl, Methoden der organischen Chemie, volume 14/2, 1963, pages 319 to 402.

Using unmodified melamine-formaldehyde precondensates is preferred according to the present invention.

The melamine-formaldehyde foams of the present invention are for example by mixing at least one melamine-formaldehyde precondensate, optionally at least one solvent, optionally at least one acid, optionally at least one dispersant, at least one blowing agent and at least one inorganic filling material of the present invention and foaming up this mixture at a temperature above the boiling temperature of the at least one blowing agent.

The present invention accordingly also provides a process for producing a melamine-formaldehyde foam wherein at least one melamine-formaldehyde precondensate, optionally at least one solvent, optionally at least one acid, optionally at least one dispersant, at least one blowing agent and at least one inorganic filling material having a density of at least 3 g/cm³ are mixed and foaming this mixture at a temperature above the boiling temperature of the at least one blowing agent.

As melamine-formaldehyde precondensates there may be used specially prepared (see reviews: a) W. Woebcken, Kunststoffhandbuch 10. Duroplaste, Munich, Vienna 1988, b) Encyclopedia of Polymer Science and Technology, 3rd edition, Vol. 1, Amino Resins, pp. 340 to 370, 2003 c) Ullmann's Encyclopedia of Industrial Chemistry, 6th edition, Vol. 2, Amino Resins, pp. 537 to 565. Weinheim 2003) or commercially available precondensates of the two components, melamine and formaldehyde. The melamine-formaldehyde precondensates generally have a molar ratio of formaldehyde to melamine in the range from 5:1 to 1.3:1 and preferably in the range from 3.5:1 to 1.5:1.

A preferred version of the process for producing the foam of the present invention comprises the stages of

(1) producing a suspension comprising a melamine-formaldehyde precondensate of the foam to be produced, at least one inorganic filling material having a density of at least 3 g/cm³ and optionally further added components,

(2) foaming the precondensate by heating the suspension from step (1) to a temperature above the boiling temperature of the blowing agent,

(3) drying the foam obtained from step (2).

The individual process steps and the various possible versions will now be more particularly discussed.

The melamine-formaldehyde precondensate may be prepared in the presence of alcohols, for example methanol, ethanol or butanol in order that partially or fully etherified condensates may be obtained. Forming the ether groups is a way of influencing the solubility of the melamine-formaldehyde precondensate and the mechanical properties of the fully cured material.

Dispersants/emulsifiers are optionally used as further added components in step (1). Anionic, cationic and nonionic surfactants and also mixtures thereof can be used as dispersant/emulsifier.

Useful anionic surfactants include for example diphenylene oxide sulfonates, alkane- and alkylbenzenesulfonates, alkylnaphthalenesulfonates, olefinsulfonates, alkyl ether sulfonates, fatty alcohol sulfates, ether sulfates, α-sulfo fatty acid esters, acylaminoalkanesulfonates, acyl isothionates, alkyl ether carboxylates, N-acylsarcosinates, alkyl and alkylether phosphates.

Useful cationic emulsifiers include for example alkyltriammonium salts, alkylbenzyldimethylammonium salts and alkylpyridinium salts.

Useful nonionic surfactants include alkylphenol polyglycol ethers, fatty alcohol polyglycol ethers, fatty acid polyglycol ethers, fatty acid alkanolamides, ethylene oxide-propylene oxide block copolymers, amine oxides, glycerol fatty acid esters, sorbitan esters and alkylpolyglycosides.

The dispersants/emulsifiers can be added in amounts from 0.2% to 5% by weight, based on the melamine-formaldehyde precondensate.

The dispersants/emulsifiers and/or protective colloids can in principle be added to the crude dispersion at any time, but they can also already be present in the solvent.

In principle, the process of the present invention can use both physical and chemical blowing agents, see Encyclopedia of Polymer Science and Technology, Vol. I, 3rd edition, Additives, pages 203 to 218, 2003. The amount of blowing agent in the mixture generally depends on the density desired for the foam.

Useful physical blowing agents include for example hydrocarbons, such as pentane, hexane, halogenated, more particularly chlorinated and/or fluorinated, hydrocarbons, for example methylene chloride, chloroform, trichloroethane, chlorofluorocarbons, hydrochlorofluorocarbons (HCFCs), alcohols, for example methanol, ethanol, n-propanol or isopropanol, ethers, ketones and esters, for example methyl formate, ethyl formate, methyl acetate or ethyl acetate, in liquid form or air, nitrogen or carbon dioxide as gases.

Useful chemical blowing agents include for example isocyanates mixed with water, releasing carbon dioxide as active blowing agent. It is further possible to use carbonates and bicarbonates mixed with acids, in which case carbon dioxide is again produced. Also suitable are azo compounds, for example azodicarbonamide.

In a preferred embodiment of the invention, the mixture further comprises at least one blowing agent. This blowing agent is present in the mixture in an amount of preferably 0.5% to 60% by weight, more preferably 1% to 40% by weight and even more preferably 1.5% to 30% by weight, based on the melamine-formaldehyde precondensate. It is preferable to add a physical blowing agent having a boiling point between 0 and 80° C.

As curatives it is possible to use acidic compounds which catalyze the further condensation of the melamine resin. The amount of these curatives is generally in the range from 0.01% to 20% by weight and preferably in the range from 0.05% to 5% by weight, all based on the precondensate. Useful acidic compounds include organic and inorganic acids, for example selected from the group consisting of hydrochloric acid, sulfuric acid, phosphoric acid, nitric acid, formic acid, acetic acid, oxalic acid, toluenesulfonic acids, amidosulfonic acids, acid anhydrides and mixtures thereof.

In a further embodiment, in addition to the melamine-formaldehyde precondensate of the foam to be produced and the inorganic filling materials, the mixture also comprises an emulsifier and also optionally a curative and a blowing agent.

In a further embodiment, the mixture is free of further added substances. However, for some purposes it can be advantageous to add from 0.1% to 20% by weight, preferably from 0.1% to 10% by weight, based on the melamine-formaldehyde precondensate, of customary added substances other than the inorganic filling materials, such as dyes, flame retardants, UV stabilizers, agents for reducing the toxicity of fire gases or for promoting carbonization, scents, optical brighteners or pigments. These added substances preferably form a homogeneous distribution in the foam.

Useful pigments include for example the common organic pigments. These pigments can be mixed with the at least one inorganic filler beforehand.

To ensure good fire protection, the proportion of organic constituents in the foam further to the melamine-formaldehyde resin should be as low as possible. Preference in the present invention is given to foams wherein the proportion of further organic constituents is so low that they pass the A2 fire test of DIN EN 13501-1.

Step (2) of the process according to the present invention comprises the precondensate being foamed up generally by heating the suspension of the melamine-formaldehyde precondensate and of the at least one inorganic filling material to obtain a foam comprising at least one inorganic filling material having a density of at least 3 g/cm³. To this end, the suspension is generally heated to a temperature above the boiling point of the blowing agent used and foamed in a closed mold.

The introduction of energy may preferably be effected via electromagnetic radiation, for example via high-frequency radiation at 5 to 400 kW, preferably 5 to 200 kW and more preferably 9 to 120 kW per kilogram of the mixture used in a frequency range from 0.2 to 100 GHz, preferably from 0.5 to 10 GHz. Magnetrons are a useful source of dielectric radiation, and one magnetron can be used or two or more magnetrons at the same time.

The foams produced are finally dried, removing residual water and blowing agent from the foam.

An aftertreatment can also be utilized to hydrophobicize the foam. This aftertreatment preferably employs hydrophobic coating agents having high thermal stability and low flammability, for example silicones, siliconates or fluorinated compounds.

The process described preferably provides blocks/slabs of foam, which can be cut to size in any desired shapes.

The foam blocks or slabs can optionally be thermocompressed in a further process step. Thermocompression as such is known to a person skilled in the art and described for example in WO 2007/031944, EP-A 451 535, EP-A 111 860 and U.S. Pat. No. B 6,608,118. Thermocompression often provides better fixing of the inorganic filling materials to the open-cell structure of foam.

The density of the foam according to the present invention is generally in the range from 3 to 100 kg/m³, preferably in the range from 10 to 100 kg/ m³, more preferably in the range from 15 to 80 kg/m³and more preferably in the range from 25 to 75 kg/m³.

The foam preferably obtainable by the process of the present invention preferably has an open-cell structure having an open-cell content, when measured to DIN ISO 4590, of more than 50% and more particularly more than 80%.

The average pore diameter is preferably in the range from 50 to 1000 μm and more particularly in the range from 100 to 500 μm (d₅₀ value, number-averaged, determined via optical or electron microscopy combined with image analysis).

The foam of the present invention is preferably elastic. Melamine-formaldehyde foams having high inorganic contents ranging from 80% to 98% by weight generally pass the A2 fire test of DIN-EN 13501-1.

The foam obtainable by the process of the present invention can be used in various ways for thermal and acoustic insulation in building construction and in automobile, ship and track vehicle construction, the construction of spacecraft or in the upholstery industry, for example for thermal insulation in the construction industry or as sound-insulating material e.g. in automobiles, airplanes, trains, ships, etc. in passenger cells or in the engine compartment or for cushioning of sitting and lying surfaces and also for back and arm rests.

The present invention accordingly also provides for the use of a melamine-formaldehyde foam of the present invention in building construction, automobile, ship and track vehicle construction, the construction of spacecraft or in the upholstery industry.

Applications are preferably in sectors requiring high thermal stability and low flammability, for example in pore burners. The material is also useful for insulation in the environment of potent radiation that decomposes organic materials in the long term, for example nuclear power plants. The material can further be used as a “sponge” in the cleaning industry for in the cleaning of surfaces for example in the form of sponges or saturated with cleaning agents of any kind.

In particular applications it can be advantageous for the surface of the foams of the present invention to be laminated with a lamination known in principle to a person skilled in the art. Such laminations may be effected for example, with substantial retention of the acoustical properties, with so-called “open systems”, for example perforated plates, or else with “closed” systems, for example foils or plates of plastic, metal or wood.

The foams of the present invention evince an improved combination of fire properties and mechanical properties.

### EXAMPLES

Utilized standards and methods of measurement:

DIN EN 13501-1—Fire classification of construction products and building elements:

This European standard mandates the methods of classifying the fire behavior of construction products including the products within building elements.

A construction product intended for class A2 has to be tested either to EN ISO 1182 or

EN ISO 1716. Additionally, all construction products intended for class A2 have to be tested to EN 13823.

EN ISO 1716—Test method for heat of combustion:

This test method determines the potential maximum amount of heat released by a construction product on complete combustion, without reference to its practical use. The test method is relevant for classes A1 and A2. The test method makes it possible to determine not only the superior calorific value but also the inferior calorific value.

EN ISO 1182—Non-combustibility test:

This test determines which construction products make no or no significant contribution to a fire without reference to their practical use. The test method is relevant for classes A1 and A2.

EN 13823—Test method for single burning item (SBI):

This test method evaluates the potential contribution made by a construction product to a developing fire in a fire situation that simulates a single burning item (SBI) in the corner of a room close to this construction product. The test method is relevant to classes A2, B, C and D.

The A2 fire class in the subsequent inventive and comparative examples was determined to EN ISO 1716 and EN 13823.

Mechanical properties, elasticity:

Ram pressure measurements for evaluating the mechanical quality of the formaldehyde-melamine resin foams were carried out as described in U.S. Pat. No. 4,666,948. A cylindrical ram having a diameter of 8 mm and a height of 10 cm was pressed into a cylindrical sample having a diameter of 11 cm and a height of 5 cm in the direction of foaming at an angle of 90° until the sample tore. The tearing force [N], hereinafter also referred to as ram pressure value, provides information as to the mechanical quality of the foam.

### Comparative Example A

Preparation of a melamine-formaldehyde foam without filling materials (according to WO-A-2009/021963).

75 parts by weight of a spray-dried melamine-formaldehyde precondensate (molar ratio 1:3) were dissolved in 25 parts by weight of water, then 3% by weight of formic acid, 2% by weight of a sodium C₁₂/C₁₄-alkyl sulfate, 38% by weight of pentane, all based on the precondensate, were added, this was followed by stirring and then foaming in a polypropylene mold (for foaming) by irradiation with microwave energy. After foaming, the foam was dried for 30 minutes.

The melamine-formaldehyde foam has a density of 3.5 g/l and a ram pressure value of 19.7 N. The foam does not meet the A2 fire class requirements of DIN EN 13501-1.

### Comparative Example B

Preparation of a melamine-formaldehyde foam using 77.5% by weight, based on the total weight of inorganic filling material plus melamine-formaldehyde precondensate used for foam production, of finely divided barium sulfate having a density of 4.5 g/cm³ as filling material:

75 parts by weight of a spray-dried melamine-formaldehyde precondensate (molar ratio 1:3) were dissolved in 25 parts by weight of water, 3% by weight of formic acid, 2% by weight of a sodium C₁₂/C₁₄-alkyl sulfate, 38% by weight of pentane, the % by weight each being based on the precondensate, and 258 parts by weight of barium sulfate of the type Blanc Fixe F particle size distribution (“PSD”) in the range from 0.001 to 0.045 mm, average particle diameter 0.020 mm, Sachtleben Chemie GmbH, were added, this was followed by stirring and then foaming in a polypropylene mold (for foaming) by irradiation with microwave energy. After foaming, the foam was dried for 30 minutes.

The brittle melamine-formaldehyde foam has a density of 18 g/l and a ram pressure value of 5.8 N. The foam does not meet the A2 fire class requirements of DIN EN 13501-1.

### Example C

Preparation of a melamine-formaldehyde foam using 80.0% by weight, based on the total weight of inorganic filling material plus melamine-formaldehyde precondensate used for foam production, of finely divided barium sulfate having a density of 4.5 g/cm³ as filling material:

75 parts by weight of a spray-dried melamine-formaldehyde precondensate (molar ratio 1:3) were dissolved in 25 parts by weight of water, 3% by weight of formic acid, 2% by weight of a sodium C₁₂/C₁₄-alkyl sulfate, 38% by weight of pentane, the % by weight each being based on the precondensate, and 300 parts by weight of barium sulfate of the type Blanc Fixe F particle size distribution (“PSD”) in the range from 0.001 to 0.045 mm, average particle diameter 0.020 mm, Sachtleben Chemie GmbH, were added, this was followed by stirring and then foaming in a polypropylene mold (for foaming) by irradiation with microwave energy. After foaming, the foam was dried for 30 minutes.

The brittle melamine-formaldehyde foam has a density of 25 g/l and a ram pressure value of 4.2 N. The foam does meet the A2 fire class requirements of DIN EN 13501-1.

### Example 1 (Inventive)

Preparation of a melamine-formaldehyde foam using 80.0% by weight, based on the total weight of melamine-formaldehyde precondensate used for foam production and unorganic filling material, barium sulfate/melamine-formaldehyde precondensate as inorganic filling material having a density of 4.2 g/cm³.

90% by weight of barium sulfate (Blanc Fixe F, Sachtleben Chemie) was produced with 10% by weight of a spray-dried melamine-formaldehyde precondensate (molar ratio 1:3) via agglomeration in the fluidized-bed process. The pelletization experiments were carried out using a fluidized-bed spray-pelletization apparatus having a diameter of 230 mm. The binder was sprayed downwardly into a flat bed (bed height about 10-40 mm). This gave barium sulfate pellets having a size of 0.050-0.350 mm (average particle diameter 0.200 mm).

The example was carried out similarly to example C except that 300 parts by weight of pellet material comprising barium sulfate/melamine-formaldehyde precondensate (average particle diameter 0.200 mm) were used.

The melamine-formaldehyde foam has a density of 26 g/l and a ram pressure value of 21.1 N. The foam does meet the A2 fire class requirements of DIN EN 13501-1.

1.-13. (canceled)

14. A melamine-formaldehyde foam comprising from 80% to 98% by weight of at least one inorganic filling material, based on the total weight of the at least one inorganic filling material plus melamine-formaldehyde precondensate used for foam production, wherein the at least one inorganic filling material has a density of at least 3 g/cm³, and the at least one inorganic filling material is selected from the group consisting of oxides, mixed silicates, sulfates, carbonates and mixtures thereof.

15. The melamine-formaldehyde foam according to claim 14 wherein the at least one inorganic filling material has an average particle diameter (Z-average via light scattering, Malvern, Fraunhofer diffraction) of 0.05 to 2 mm.

16. The melamine-formaldehyde foam according to claim 14 wherein the at least one inorganic filling material comprises at least one binder.

17. The melamine-formaldehyde foam according to claim 16 wherein the at least one binder is selected from the group consisting of thermosets, thermoplastics, inorganic binders and mixtures thereof.

18. The melamine-formaldehyde foam according to claim 17 wherein the at least one binder is a thermoset selected from the group consisting of melamine-formaldehyde resins, polyurethane resins, polyester resins, epoxy resins and mixtures thereof.

19. The melamine-formaldehyde foam according to claim 17 wherein the at least one binder is a thermoplastic selected from the group consisting of polyethylene, polypropylene, polyesters, polycarbonates, polyamides and mixtures thereof.

20. The melamine-formaldehyde foam according to claim 17 wherein the at least one binder is an inorganic binder selected from the group consisting of phosphates, silicates, borates and mixtures thereof.

21. The melamine-formaldehyde foam according to claim 14 wherein the at least one inorganic filling material is at least partly present as spherical particles.

22. The melamine-formaldehyde foam according to claim 14 wherein the at least one inorganic filling material is at least partly embedded into the pores of the melamine-formaldehyde foam.

23. The melamine-formaldehyde foam according to claim 14 wherein the at least one inorganic filling material is obtained via pelletization process and/or extrusion operations.

24. A process for producing a melamine-formaldehyde foam according to claim 14, which comprises at least one melamine-formaldehyde precondensate, optionally at least one solvent, optionally at least one acid, optionally at least one dispersant, at least one blowing agent and at least one inorganic filling material having a density of at least 3 g/cm³ being mixed and foaming this mixture at a temperature above the boiling temperature of the at least one blowing agent.

25. A method comprising utilizing the melamine-formaldehyde foam according to claim 14 in building construction, automobile, ship and track vehicle construction, the construction of spacecraft or in the upholstery industry.

26. The melamine-formaldehyde foam according to claim 15, wherein the at least one inorganic filling material has an average particle diameter of 0.1 to 1 mm.

27. The melamine-formaldehyde foam according to claim 15, wherein the at least one inorganic filling material has an average particle diameter of 0.2 to 0.4 mm.
